(19) United States
(12) Patent Application Publication
(10) Pub. No.: US 2005/0278271 A1
(43) Pub. Date: Dec. 15, 2005

(54) System and method for determining a product configuration

(76) Inventors: James T. Anthony, Noblesville, IN (US); Thomas C. Gaunt, Indianapolis, IN (US); Randy L. Norman, Greenwood, IN (US); Joseph R. Ehrlich, Indianapolis, IN (US); Bonnie F. London, Sheridan, IN (US)

Correspondence Address: BARNES & THORNBURG, 11 SOUTH MERIDIAN, INDIANAPOLIS, IN, 46204, US

(21) Appl. No.: 11/129,466

(22) Filed: May 13, 2005

Related U.S. Application Data
(60) Provisional application No. 60/571,138, filed on May 14, 2004.

(51) Int. Cl. G06F 3/00; G06F 9/00; G06F 17/00

(52) U.S. Cl. 706/919

(57) ABSTRACT

A system for determining a product configuration comprises a database of existing components, a computer in data communication with the database, and a CAD server. The computer includes a product configurator engine responsive to a set of customer requirements for a specified product to retrieve information from the database relating to a number of components in the database that will be used to define the specified product. At least part of the retrieved information is CAD information. The CAD server is responsive to the CAD information to produce a description of the specified product.

### CROSS-REFERENCE TO RELATED U.S. APPLICATIONS

This application claims priority to, and the benefit of, U.S. provisional patent application Ser. No. 60/571,138, filed May 14, 2004, the disclosure of which is incorporated herein by reference.

### FIELD OF THE INVENTION

The present invention relates generally to techniques for designing products, and more specifically to systems and methods for configuring specified products from existing components

### BACKGROUND

Configuring new products from existing components is typically time consuming and often requires multiple iterations to complete. It is desirable to automate the product configuration process to thereby shorten the product design time.

### SUMMARY

The present invention may comprise one or more of the features recited in the attached claims, and/or one or more of the following features and combinations thereof. A method of determining a product configuration may comprise acquiring customer requirements for a specified product. The customer requirements may be processed to produce information relating to manufacture of the specified product. At least part of the information relating to manufacture of the specified product may be CAD information relating to a number of components comprising the specified product. The CAD information may be processed to produce a description of the specified product. The description of the specified product may be provided to the customer.

Processing the customer requirements may include processing the customer requirements with a product configurator software engine in communication with a database of existing components. At least another part of the information relating to manufacture of the specified product may be a bill of materials. Processing the customer requirements may include retrieving data relating to each of the number of components from the database of existing components and generating the bill of materials therefrom. At least a further part of the information relating to manufacture of the specified product may be a router. Processing the customer requirements may include automatically generating the router from the bill of materials. The router may include a list of the number of components comprising the specified product. The router may further include assembly instructions relating to assembly of the specified product from the number of components comprising the specified product. The router may further include an assembly time relating to a time duration required to manufacture the specified product from the number of components comprising the specified product. The router may further include cost data relating to a cost of manufacturing the specified product.

The CAD information may include CAD identifiers for each of the number of components comprising the specified product. Processing the CAD information may include assembling the CAD identifiers in a format usable by a CAD server. Processing the CAD information may further include processing the assembled CAD identifiers with the CAD server to produce the product description. The product description may include a product description sheet describing manufacture of the specified product. The product description may alternatively or additionally include a 2-dimensional drawing of the specified product. The product description may alternatively or additionally include a 3-dimensional model of the specified product.

Providing the description of the specified product to the customer may include providing the description of the specified product in the form of one or more hard copies. Providing the description of the specified product to the customer may alternatively or additionally include providing the description of the specified product in an electronic format accessible by the customer. Providing the description of the specified product to the customer may include electronically transferring the description of the specified product to the customer. Electronically transferring the description of the specified product may include electronically transferring the description via the world wide web. A viewer application may additionally be electronically transferred. The viewer application may be usable by the customer to allow the customer to read the description of the specified product. Additional data may be attached to the description of the specified product. The additional data may relate to one or more of the number of components comprising the specified product.

The method may further include subjecting the customer requirements for the specified product to at least one rule check prior to processing the customer requirements. The method may further include modifying the customer requirements if the customer requirements do not pass the at least one rule check.

A method of automating a process for determining a product configuration may comprise acquiring customer requirements for a specified product, entering the customer requirements into a product configurator software engine, generating a configurator output of the product configurator software engine based on the customer requirements, providing a functional companion for allowing the configurator software engine to communicate with a CAD server, providing at least part of the configurator output to the CAD server via the functional companion, and generating at least one CAD drawing of the specified product with the CAD server using the at least part of the configurator output.

A system for determining a product configuration may comprise a database of existing components, a computer in data communication with the database, and a CAD server. The computer may include a product configurator engine responsive to a set of customer requirements for a specified product to retrieve information from the database relating to a number of components in the database that will be used to define the specified product. At least part of the retrieved information may be CAD information. The CAD server may be responsive to the CAD information to produce a description of the specified product.

The computer may further include a CAD interface for providing the CAD information to the CAD server in a format usable by the CAD server.

The system may further include means for providing the customer requirements to the computer.

The system may further include an electronic device for transferring the customer requirements to the computer. The electronic device may be configured to transfer the customer requirements to the computer wirelessly. The electronic device may be configured to transfer the customer requirements to the computer via the world wide web.

The CAD server may be configured to provide the description of the specified product to the computer. The computer may electronically transfer the description of the specified product to the electronic device. The computer may be configured to wirelessly transfer the description of the specified product to the electronic device. The computer may be configured to electronically transfer the description of the specified product to the electronic device via the world wide web. The computer may be further configured to electronically transfer a viewer application to the electronic device. The viewer application may allow viewing of the description of the specified product via the electronic device.

### BRIEF DESCRIPTION OF THE DRAWINGS

FIG. 1 is a block diagram of one illustrative embodiment of a system for determining a product configuration.

FIG. 2 is a flowchart of one illustrative embodiment of a process for determining a product configuration.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

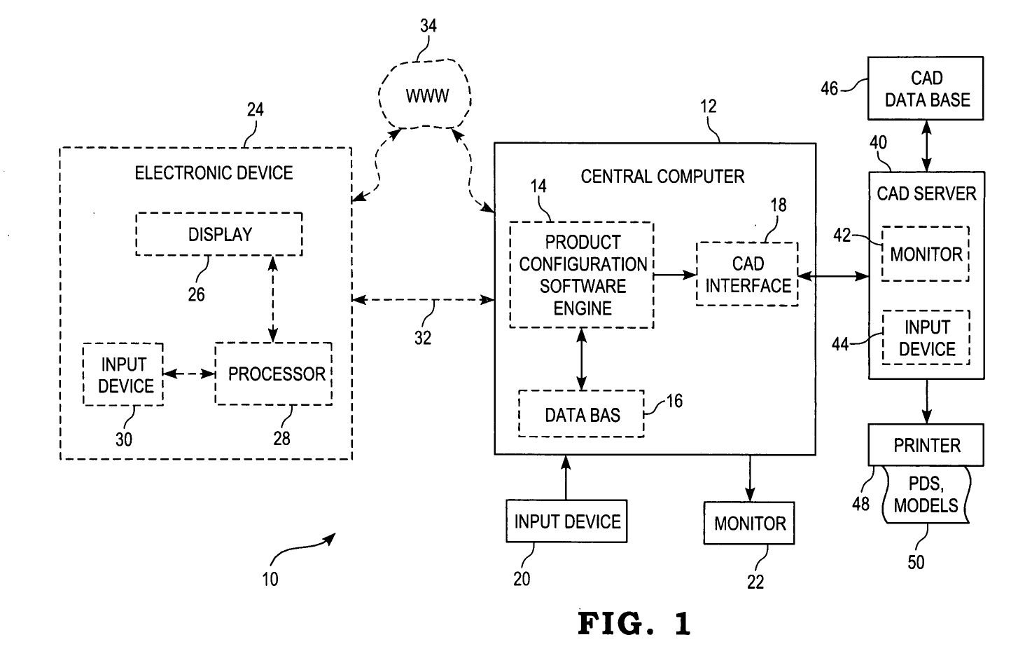

Referring now to FIG. 1, a block diagram of one illustrative embodiment of a system 10 for determining a product configuration is shown. In the illustrated embodiment, the system 10 includes a central computer 12, which may be provided in the form of a general purpose computer, central server, personal computer (PC), or the like. In any case, the computer 12 include a product configuration software engine or product configurator 14 in data communications with a database 16 and a computer-aided-design (CAD) interface 18. The product configuration software engine 14 is operable, as will be described in greater detail hereinafter, to automatically determine a product configuration for a product specified by a customer or other user. The database 16 is, in the illustrated embodiment, a central database having stored therein dimensional, cost, and other information relating to existing components from which a new product may be assembled, manufactured or otherwise created. In one embodiment, the database 16 is an Oracle™ database and the product configurator 14 is an Oracle™ ERP 11i configurator. The CAD interface 18 is, in the illustrated embodiment, a functional companion operable in a conventional manner to receive CAD identifiers from the product configurator 14, and to package or assemble the CAD identifiers in a format that is usable by a CAD server 40.

The central computer 12 further includes an input device 20 that may be used in a conventional manner to input and/or modify customer requirements for a specified product. A monitor 22 is also included for viewing information relating to the computer 12. In one embodiment, the input device 20 may be or include a conventional keyboard or key pad for entering alphanumeric data into the computer 12. Alternatively or additionally, the input device 20 may be or include a conventional mouse or other conventional point and click device for selecting information presented on the monitor 22. Alternatively or additionally, the input device 20 may be or include a conventional memory retrieval unit operable to retrieve information from a corresponding memory medium and provide such information to the computer 12. Examples of such a memory medium include, but are not limited to, a compact disk (CDROM), a so-called floppy disk, a memory stick, or the like.

Optionally, as shown in dashed line representation in FIG. 1, the system 10 may include an electronic device 24 for communicating information between a customer or other user and the central computer 12. In this embodiment, the electronic device 24 includes a conventional display 26 in data communications with a conventional processor 28 that is also in data communications with a conventional input device 30. The input device 30 may be or include any of the input device embodiments described hereinabove with respect to the input device 20. The electronic device 24 may be another computer, such as a general purpose computer, a PC, a laptop, a notebook, or other computer, a conventional hand-held or so-called personal data assistant (PDA) device, a cellular telephone, camera or other such electronic device. In the illustrated embodiment, information relating to customer requirements for a new or specified product may be entered into the electronic device 24, and then transferred to the central computer 12. Information from the central computer 12 may likewise be transferred back to the electronic device 24. In one embodiment, this transfer of information may occur via a wired or wireless connection 32 between the electronic device 24 and the central computer 12, wherein the wired or wireless connection 32 may be configured to communicate information between the device 24 and computer 12 via any desired communications protocol. Alternatively or additionally, the electronic device 24 and the central computer 12 may each be configured to access the world wide web (WWW) 34, or other inter or intra net communication medium. In this case, information may be shared between the electronic device 24 and the central computer 12 via the WWW 34 in a conventional manner.

The system 10 further includes a CAD server 40 including a conventional monitor 42 an a conventional input device 44, wherein the input device 44 may be or include any of the embodiments described hereinabove with respect to the input device 20. In one embodiment, the CAD server 40 is a Unigraphics Next Generation CAD server (UG NX CAD), although other CAD servers or systems may be used. In any case, the CAD server 40 is in data communications with a CAD database 46, and is also in data communications with a conventional printer 48. It will be understood that while the CAD server 40 and CAD database 46 are illustrated as being separate components from the central computer 12, the CAD server 40 and/or CAD database 46 may alternatively form part of the central computer 12.

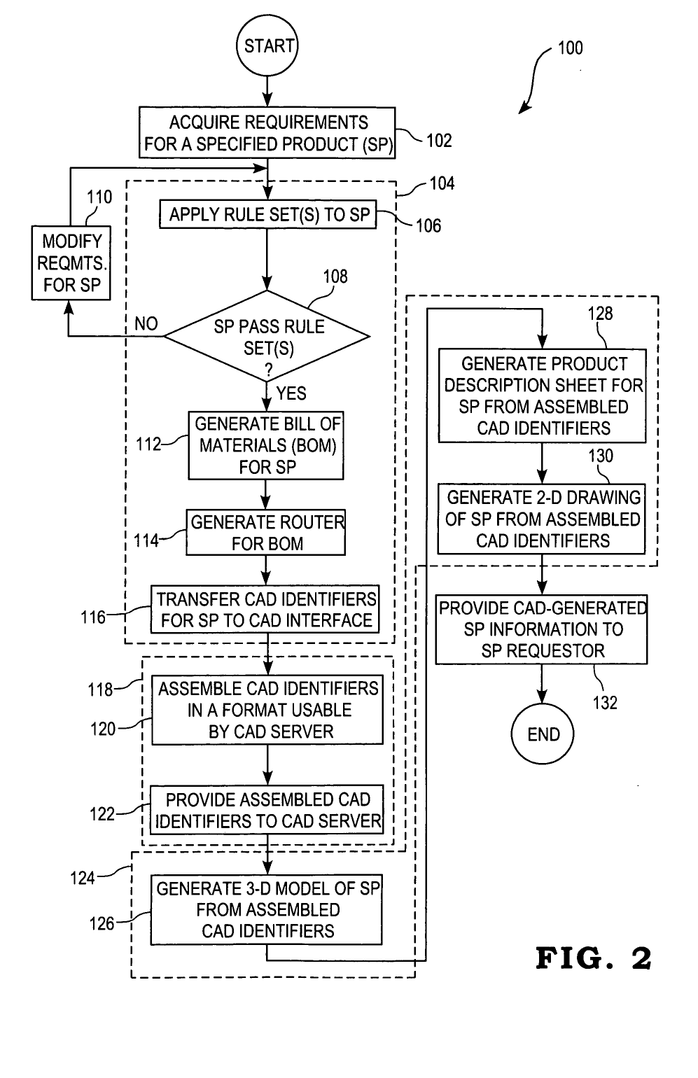

Referring now to FIG. 2, a flowchart is shown of one illustrative embodiment of a process 100 for determining a product configuration. The process 100 is automated, and will be described in the context of being carried out using the system 10 of FIG. 1 with various portions of the process 100 being carried out in different components of the system 10 as will be described in greater detail hereinafter. The process 100 begins at step 102 where the central computer 12 acquires the requirements for a specified product (SP) from a customer or other user. In one embodiment, the customer requirements are communicated in written or verbal form to a sales or other representative, and these requirements are then entered into the computer 12 via the input device 20. Alternatively, the sales or other representative or the customer may enter the customer requirements into an electronic device 24, which is then controlled to transfer the customer requirements to the central computer 12 via the communication medium 32 or 34. In such cases, the customer requirements transferred to the central computer 12 may be modified via the input device 20 before being acted upon by the computer 12. In any case, the customer requirements are provided to the product configurator 14 within the central computer 12.

Following step 102, control of the process 100 is transferred to the product configurator 14, as indicated generally by the dashed-line block 104, and at step 106 the product configurator 14 is operable to conduct a rules check by applying one or more rule or regulation sets to the customer requirements for the specified product. The one or more rule or regulation sets may serve as product configuration guidelines, and may include for example and without limitation the Federal Motor Vehicle Safety Standards (“FMVSS”). Thereafter at step 108, the product configurator is operable to determine whether the current customer requirements defining the specified product pass the one or more rule or regulation sets. If not, the process advances to step 110.

At step 110, the customer, sales representative or other user modifies the customer requirements for the specified product in the same manner as the customer requirements were entered into the computer 12. In this embodiment, step 110 is outside of the control of the product configurator 14. In an alternative embodiment, step 110 is inside of the control of the product configurator, and steps 102-110 form an interactive loop wherein the product configurator 14 is responsive to the customer requirements to recommend and/or display optional components from the database 16 that may be used in the specified product, wherein all such optional components are “pre-approved” by the product configurator 14 in the sense that they do or will pass the one or more rule checks. The user then selects appropriate components from the approved list or display for inclusion in the specified product. In any case, when the customer requirements for the specified product pass all of the rule or requirement checks, the process advances to step 112.

At step 112, the product configurator 14 is operable to generate a bill of materials (BOM) from the customer requirements for the specified product. The bill of materials, in the illustrated embodiment, includes a list of components and related component information from existing component information stored in the database 16. In alternative embodiments, the bill of materials may include more or less information. Following step 112, the process 100 advances to step 114 where the product configurator 14 is operable to automatically generate in real-time or near real-time a router from the bill of materials and from the one or more rule sets. In one embodiment, the router includes a listing of manufacturing elements required to assemble the specified product. Alternatively or additionally, the router may include instructions for assembling the specified product. Alternatively or additionally, the router may include time and cost information required to assemble or manufacture the specified product. Alternatively or additionally, the router may include the total cost of the specified product. In addition to the router, the product configurator 14 may generate a uniform cost or material labor and overhead listing (MLO) setting forth uniform costs in the form of material labor and/or overhead, wherein such uniform cost information is stored in the database 16.

From step 114, the process 100 advances to step 114 where the product configurator transfers CAD identifiers for the specified product to the CAD interface 18. Generally, the CAD identifiers may include CAD identifiers for each component in the bill of materials, as well as CAD identifiers relating to the assembly and/or final configuration of the specified product, as specified by the customer requirements.

From step 116, control of the process 100 is transferred to the CAD interface 18, as indicated generally by the dashed-line block 118, and at step 120 the CAD interface 18 is operable to package or assemble the CAD identifiers in a form usable by the CAD server 40. Thereafter at step 122, the CAD interface 18 is operable to transfer the CAD identifiers to the CAD server 40 via a software pipeline, such as a Unigraphics (UG) Knowledge Fusion Pipeline.

From step 118, control of the process 100 is transferred to the CAD server 40, as indicated generally by the dashed-line block 124, and at step 126 the CAD server 40 is operable to generate a 3-dimensional model of the specified product from the CAD identifiers and from component information stored in the CAD database 46. Thereafter at step 128, the CAD server 40 is operable to generate a product description sheet 50 (see FIG. 1), or PDS, from the CAD identifiers and from component information stored in the CAD database 46. The PDS generally describes manufacture of the specified product, and may be used by workers to assemble, manufacture or otherwise produce the specified product. The process 100 next advances to step 130 where the CAD server 40 is operable to generate a 2-dimensional drawing of the specified product from the CAD identifiers and from component information stored in the CAD database 46. The 3-dimensional model, PDS and 2-dimensional drawing are generated by the CAD server in real-time or near real-time.

Following step 130, the process 100 advances to step 132 where some or all of the CAD-generated information relating to the specified product is provided to the customer or other requestor. In one embodiment, some or all of the CAD-generated information is provided to the customer or other requestor in the form of hard copies. Alternatively or additionally, some or all of the CAD-generated information may be provided to the customer or other requestor electronically. In this embodiment, the CAD server 40 is operable to transfer some or all of the CAD-generated information back to the central computer 12 via the software pipeline. The computer 12 is then operable to send some or all of the CAD-generated information, in real-time or near real-time, to the electronic device 24 via either of the communication paths 32 or 34, along with an application viewer that will allow the customer or other user to view the CAD-generated information. In one specific embodiment, the application viewer is an Oracle™ CadView 2D and 3D viewer. In embodiments wherein the configurator 14 is an Oracle™ configurator, the database 16 is an Oracle™ database and the application view is an Oracle™ CadView 2D and 3D viewer, the computer 12 may be configured to send additional information from the database 16 that relates to the specified product to the electronic device 24. For example, the additional information may include dimensional, cost or other information associated with each component comprising the specified product. This allows the customer or other user to, for example, select any component comprising the specified product to learn more about that specific component. Other examples will occur to those skilled in the art, and such other examples are contemplated by this disclosure.

A system and process for determining a product configuration for a custom-designed product is provided. Specifically, the system and process relate to determining the configuration of a custom-designed or specified product and allows a customer to custom design a product from existing components while providing near real-time or real-time production of the cost estimates to produce the product, the bill of materials, and 2D as well as 3D CAD models of the custom-designed product. The process includes capturing customer requirements or specifications for the new custom-designed product to be manufactured, entering the customer requirements into a configurator-type software program, running the configurator-type software program to generate an output, processing the output through a CAD database, and generating CAD models based upon the output.

As mentioned above, the system and process provide real-time or near real-time benefits to a customer or other user by providing Sales (Account Managers, Inside Sales, Sales Reps, and in some cases, the customer) and Engineering Services with a user friendly application engineering tool that would speed up the product evaluation and selection process, while streamlining the compilation of data, including drawings, bill of materials, routers, costing, etc., for cost-quoting and potential manufacturing use. The process results in a reduction in process time from meeting with the customer to providing the compiled output data of the new product configuration.

Customer requirements are captured and applied against product and application rule based logic residing in a software configurator module, an example being Oracle Configurator, which is then processed through a software pipeline to a CAD database, such as UG Knowledge Fusion Pipeline and NX CAD, where CAD 3D models and 2D drawings are viewable by the user and stored for future use. This process allows for the selection and development of bills of material (BOMs), routers, costing as well as use of configurations for customer CAD drawings, CAD PDSs and CAD 3D models for customer space claim. In general, routers take the bill of materials and documents the process for assembling the parts of the product, the steps for assembling the parts of the product, the time required to assemble the parts of the product, and the estimated costs involved with assembling the costs of the product.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

1. A method of determining a product configuration comprising:
acquiring customer requirements for a specified product,
processing the customer requirements to produce information relating to manufacture of the specified product, at least part of the information relating to manufacture of the specified product being CAD information relating to a number of components comprising the specified product,
processing the CAD information to produce a description of the specified product, and
providing the description of the specified product to the customer.

2. The method of claim 1 wherein processing the customer requirements includes processing the customer requirements with a product configurator software engine in communication with a database of existing components.

3. The method of claim 2 wherein at least another part of the information relating to manufacture of the specified product is a bill of materials,
and wherein processing the customer requirements includes retrieving data relating to each of the number of components from the database of existing components and generating the bill of materials therefrom.

4. The method of claim 3 wherein at least a further part of the information relating to manufacture of the specified product is a router,
and wherein processing the customer requirements includes automatically generating the router from the bill of materials and from one or more rule sets, the router including a list of the number of components comprising the specified product.

5. The method of claim 4 wherein the router further includes assembly instructions relating to assembly of the specified product from the number of components comprising the specified product.

6. The method of claim 4 wherein the router further includes an assembly time relating to a time duration required to manufacture the specified product from the number of components comprising the specified product.

7. The method of claim 4 wherein the router further includes cost data relating to a cost of manufacturing the specified product.

8. The method of claim 1 wherein the CAD information includes CAD identifiers for each of the number of components comprising the specified product.

9. The method of claim 8 wherein processing the CAD information includes assembling the CAD identifiers in a format usable by a CAD server.

10. The method of claim 9 wherein processing the CAD information further includes processing the assembled CAD identifiers with the CAD server to produce the product description.

11. The method of claim 10 wherein the product description includes a product description sheet describing manufacture of the specified product.

12. The method of claim 10 wherein the product description further includes a 2-dimensional drawing of the specified product.

13. The method of claim 10 wherein the product description further includes a 3-dimensional model of the specified product.

14. The method of claim 10 wherein providing the description of the specified product to the customer includes providing the description of the specified product in the form of one or more hard copies.

15. The method of claim 10 wherein providing the description of the specified product to the customer includes providing the description of the specified product in an electronic format accessible by the customer.

16. The method of claim 15 wherein providing the description of the specified product to the customer includes electronically transferring the description of the specified product to the customer.

17. The method of claim 16 wherein electronically transferring the description of the specified product includes electronically transferring the description via the world wide web.

18. The method of claim 16 further including electronically transferring a viewer application usable by the customer to allow the customer to read the description of the specified product.

19. The method of claim 16 further including attaching additional data to the description of the specified product, the additional data relating to one or more of the number of components comprising the specified product.

20. The method of claim 1 further including subjecting the customer requirements for the specified product to at least one rule check prior to processing the customer requirements.

21. The method of claim 20 further including modifying the customer requirements if the customer requirements do not pass the at least one rule check.

22. A method of automating a process for determining a product configuration comprising:
acquiring customer requirements for a specified product,
entering the customer requirements into a product configurator software engine,
generating a configurator output of the product configurator software engine based on the customer requirements,
providing a CAD interface for allowing the configurator software engine to communicate with a CAD server,
providing at least part of the configurator output to the CAD server via the functional companion, and
generating at least one CAD model of the specified product with the CAD server using the at least part of the configurator output.

23. A system for determining a product configuration comprising:
a database of existing components,
a computer in data communication with the database, the computer including a product configurator engine responsive to a set of customer requirements for a specified product to retrieve information from the database relating to a number of components in the database that will be used to define the specified product, at least part of the retrieved information being CAD information, and
a CAD server responsive to the CAD information to produce a description of the specified product.

24. The system of claim 23 wherein the computer further includes a CAD interface for providing the CAD information to the CAD server in a format usable by the CAD server.

25. The system of claim 23 further including means for providing the customer requirements to the computer.

26. The system of claim 23 further including an electronic device for transferring the customer requirements to the computer.

27. The system of claim 26 wherein the electronic device is configured to transfer the customer requirements to the computer wirelessly.

28. The system of claim 26 wherein the electronic device is configured to transfer the customer requirements to the computer via the world wide web.

29. The system of claim 26 wherein the CAD server is configured to provide the description of the specified product to the computer, the computer electronically transferring the description of the specified product to the electronic device.

30. The system of claim 29 wherein the computer is configured to wirelessly transfer the description of the specified product to the electronic device.

31. The system of claim 29 wherein the computer is configured to electronically transfer the description of the specified product to the electronic device via the world wide web.

32. The system of claim 29 wherein the computer is further configured to electronically transfer a viewer application to the electronic device, the viewer application allowing viewing of the description of the specified product via the electronic device.
